(19) United States
(12) Patent Application Publication
(10) Pub. No.: US 2021/0250472 A1
(43) Pub. Date: Aug. 12, 2021

(54) DUAL-VISION CAMERA, GIMBAL SYSTEM AND MOVABLE PLATFORM

(71) Applicant: SZ DJI TECHNOLOGY CO., LTD., Shenzhen (CN)

(72) Inventors: Yucheng LIU, Shenzhen (CN); Jun DU, Shenzhen (CN); Bo LIANG, Shenzhen (CN)

(21) Appl. No.: 17/244,300

(22) Filed: Apr. 29, 2021

Related U.S. Application Data
(63) Continuation of application No. PCT/CN2018/122114, filed on Dec. 19, 2018.

(30) Foreign Application Priority Data
Oct. 31, 2018 (CN) 201821798864.2

(51) Int. Cl. H04N 5/225; G03B 17/08; F16M 11/12; G03B 17/56

(52) U.S. Cl. CPC H04N 5/2252; G03B 17/08; G03B 17/561; F16M 11/123; H04N 5/22521

(57) ABSTRACT

The present disclosure provides a dual-vision camera, including a front housing, a middle housing, a rear housing, a first camera module, and a second camera module. The front, middle, and the rear housings are connected, forming a receiving cavity, the front housing including a front wall and a rear wall, the rear wall being disposed in the receiving cavity, and being recessed toward the front wall, forming a first storage space and a second storage space. The first camera module includes a first circuit board mounted on the front housing rear wall, and a first module body extending into the first storage space. The second camera module includes a second circuit board mounted on the front housing rear wall, and a second module body extending into the second storage space.

### CROSS-REFERENCE TO RELATED APPLICATIONS

This application is a continuation of International Application No. PCT/CN2018/122114, filed on Dec. 19, 2018, which claims priority to Chinese patent application No. 201821798864.2 filed with the Chinese Patent Office on Oct. 31, 2018, the entire content of both of which are incorporated herein by reference.

### TECHNICAL FIELD

The present disclosure relates to the technical field of gimbal and, more specifically, to a dual-vision camera, a gimbal system, and a movable platform.

### BACKGROUND

In conventional technology, unmanned aerial vehicles (UAVs) can be used in the fields of aerial photography, surveying and mapping, and detection. The UAV is generally equipped with a gimbal to solve the shaking problem of devices such as cameras, sensors, and other components on the UAV.

Generally, cameras, sensors, and other components can be carried by the gimbal. For example, a single-vision camera can be carried by the gimbal to perform image capturing while archiving stabilization. During the flight of the UAV, due to factors such as operation and positioning accuracy, the gimbal may be hit, and the devices carried by the gimbal may also be hit and damaged. Once a device is damaged, it needs to be replaced as a whole. At the same time, single-vision cameras cannot be effectively used in night shooting for detection scenes, such as forest fire prevention and car chasing, and cannot meet the users' shooting needs.

### SUMMARY

One aspect of the present disclosure provides a dual-vision camera. The dual-vision camera includes a front housing; a middle housing; a rear housing; a first camera module; and a second camera module. The front housing, the middle housing, and the rear housing are connected in sequence to form a receiving cavity, the front housing including a front housing front wall and a front housing rear wall disposed opposite the front housing front wall, the front housing rear wall being disposed in the receiving cavity, and the front housing rear wall being recessed toward the front housing front wall forming a first storage space and a second storage space. The first camera module includes a first circuit board and a first module body, the first circuit board being mounted on the front housing rear wall and the middle housing, and the first module body extending into the first storage space. The second camera module includes a second circuit board and a second module body, the second circuit board being mounted on at least one of the front housing rear wall or the middle housing, and the second module body extending into the second storage space. A connecting part is disposed on the middle housing to connect the dual-vision camera and a gimbal.

Another aspect of the present disclosure provides a gimbal system. The gimbal system includes a gimbal, and a dual-vision camera. The dual-vision camera includes a front housing; a middle housing; a rear housing; a first camera module; and a second camera module. The front housing, the middle housing, and the rear housing are connected in sequence to form a receiving cavity, the front housing including a front housing front wall and a front housing rear wall disposed opposite the front housing front wall, the front housing rear wall being disposed in the receiving cavity, and the front housing rear wall being recessed toward the front housing front wall forming a first storage space and a second storage space. The first camera module includes a first circuit board and a first module body, the first circuit board being mounted on the front housing rear wall and the middle housing, and the first module body extending into the first storage space. The second camera module includes a second circuit board and a second module body, the second circuit board being mounted on at least one of the front housing rear wall or the middle housing, and the second module body extending into the second storage space. A connecting part is disposed on the middle housing to connect the dual-vision camera and the gimbal.

Another aspect of the present disclosure provides a movable platform. The movable platform includes a movable platform body; and a gimbal system being installed on the movable platform body. The gimbal system includes a gimbal; and a dual-vision camera being carried by the gimbal. The dual-vision camera includes a front housing; a middle housing; a rear housing; a first camera module; and a second camera module. The front housing, the middle housing, and the rear housing are connected in sequence to form a receiving cavity, the front housing including a front housing front wall and a front housing rear wall disposed opposite the front housing front wall, the front housing rear wall being disposed in the receiving cavity, and the front housing rear wall being recessed toward the front housing front wall forming a first storage space and a second storage space. The first camera module includes a first circuit board and a first module body, the first circuit board being mounted on the front housing rear wall and the middle housing, and the first module body extending into the first storage space. The second camera module includes a second circuit board and a second module body, the second circuit board being mounted on at least one of the front housing rear wall or the middle housing, and the second module body extending into the second storage space. A connecting part is disposed on the middle housing to connect the dual-vision camera and the gimbal.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a three-dimensional (3D) assembly diagram of an input and output component according to some embodiments of the present disclosure.

FIG. 2 is a 3D exploded schematic view of the input and output component shown in FIG. 1 from one perspective.

FIG. 3 is a 3D exploded schematic view of the input and output component shown in FIG. 1 from another perspective.

FIG. 4 is a 3D exploded schematic view of the input and output component shown in FIG. 1 from another perspective.

FIG. 5 is a 3D schematic diagram of a front housing of the input and output component shown in FIG. 2.

FIG. 6 is a 3D schematic diagram of the front housing of the input and output component shown in FIG. 2 from another perspective.

FIG. 7 is a 3D schematic diagram of the front housing of the input and output component shown in FIG. 2 from another perspective.

FIG. 8 is a schematic plan view of the input and output component according to some embodiments of the present disclosure.

FIG. 9 is a 3D structural diagram of a middle housing of the input and output component shown in FIG. 2.

FIG. 10 is a 3D structural diagram of the middle housing of the input and output component shown in FIG. 2 from another perspective.

FIG. 11 is a partial structural diagram of the input and output component according to some embodiments of the present disclosure.

FIG. 12 is a partial 3D exploded diagram of the input and output component according to some embodiments of the present disclosure.

FIG. 13 a schematic structural diagram of an input and output module in the input and output component being installed on the front housing according to some embodiments of the present disclosure.

FIG. 14 a schematic structural diagram of the input and output module and a heat sink in the input and output component being installed on the front housing according to some embodiments of the present disclosure.

FIG. 15 is a partial structural diagram of the input and output component according to some embodiments of the present disclosure.

FIG. 16 and FIG. 17 are 3D cross-sectional diagrams of the input and output component according to some embodiments of the present disclosure.

FIG. 18 is a schematic diagram of a connection between a main board of the input and output component and the input and output module according to some embodiments of the present disclosure.

FIG. 19 is a schematic structural diagram of a gimbal system according to some embodiments of the present disclosure.

FIG. 20 is a schematic structural diagram of a movable platform according to some embodiments of the present disclosure.

### DETAILED DESCRIPTION OF THE EMBODIMENTS

Reference will now be made in detail to exemplary embodiments, examples of which are illustrated in the accompanying drawings, in which the same or similar reference numbers throughout the drawings represent the same or similar elements or elements having same or similar functions. Embodiments described below with reference to drawings are merely exemplary and used for explaining the present disclosure, and should not be understood as limitation to the present disclosure.

In the present disclosure, unless explicitly stated and defined otherwise, the first feature “above” or “below” the second feature may be that the first feature and the second feature are in direct contact, or that the first feature and the second feature are in indirect contact via an intermediate medium. Moreover, the first feature is “above” the second feature may be that the first feature is directly above or obliquely above the second feature, or it only indicates that a horizontal height of the first feature is greater than the horizontal height of the second feature. The first feature is “below” the second feature may be that the first feature may be directly below or obliquely below the second feature, or it may simply indicate that a horizontal height of the first feature is less than the horizontal height of the second feature.

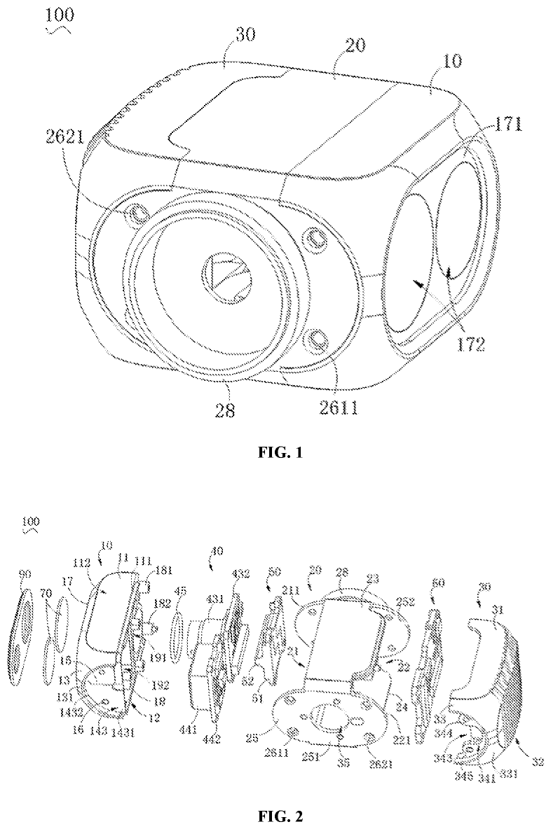

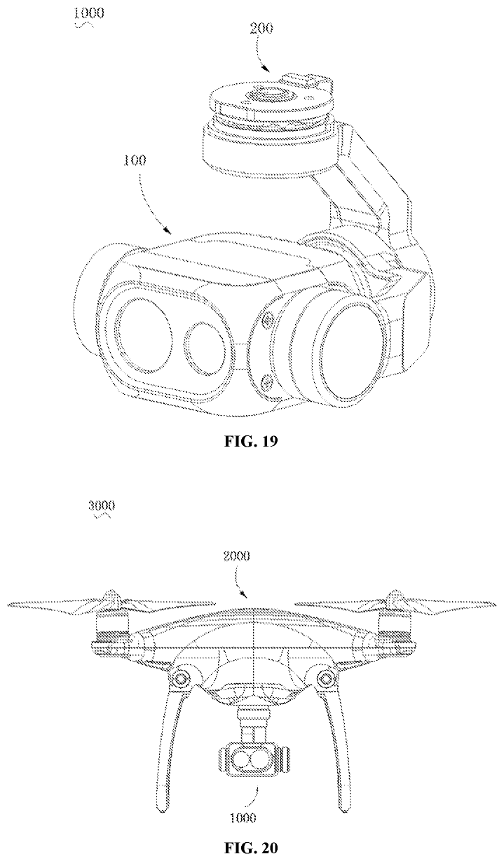

Referring to FIG. 1 and FIG. 2, an embodiment of the present disclosure provides an input and output component 100 that can be applied to a gimbal 200 (shown in FIG. 19).

In some embodiments, the input and output component 100 may include a dual-vision camera. The dual-vision camera is a form of an input and output component 100. The dual-vision camera includes a front housing 10, a middle housing 20, a rear housing 30, a first camera module 43, and a second camera module 44. The front housing 10, the middle housing 20, and the rear housing 30 are connected in sequence to form a receiving cavity 80. The front housing 10 includes a front housing front wall 17 and a front housing rear wall 18 disposed opposite to each other, and the front housing rear wall 18 is positioned in the receiving cavity 80. The front housing rear wall 18 is recessed toward the front housing front wall 17 to form a first storage space 191 and a second storage space 192. The first camera module 43 includes a first circuit board 432 and a first module body 431. The first circuit board 432 is mounted on the front housing rear wall 18 and/or the middle housing 20. The first module body 431 extends into the first storage space 191. The second camera module 44 includes a second circuit board 442 and a second module body 441. The second circuit board 442 is mounted on the front housing rear wall 18 and/or the middle housing 20. The second module body 441 extends into the second storage space 192. The middle housing 20 may further include a connecting part, and the connecting part can be used to connect the dual-vision camera and the gimbal 200.

It can be understood that the connection between the dual-vision camera and the gimbal 200 may be a fixed connection or a detachably connection.

In the dual-vision camera provided by the embodiments of the present disclosure, by using the design of the front housing, the middle housing, and the rear housing, when one of the front housing 10, the middle housing 20, the rear housing 30, the first camera module 43, and the second camera module 44 is damaged, it can be replaced without the need to replace the dual-vision camera as a whole, which is beneficial to reduce the cost and improve the maintenance of the dual-vision camera. At the same time, the first module body 431 of the first camera module 43 can extend into the first storage space 191 for positioning, and the second module body 441 of the second camera module 44 can extend into the second storage space 192 for positioning. The relative position between the first module body 431 and the second module body 441 can be fixed by a storage space 19, without manual adjustment by the assembler, which simplifies the installation process of the dual-vision camera. In addition, the first camera module 43 and the second camera module 44 can be positioned on the front housing 10, such that the user does not need to adjust the optical axes of the first camera module 43 and the second camera module 44 for the two optical axes to be parallel to each other, which is convenient for calibration and the installation the first camera module 43 and the second camera module 44 with each other.

Referring to FIG. 2 to FIG. 4, other than the dual-vision camera described above, in some embodiments, the input and output component 100 may also take other forms. For example, the input and output component 100 may include a front housing 10, a middle housing 20, a rear housing 30, a plurality of input and output modules 40, a heat sink 50, and a main board 60. The front housing 10, the middle housing 20, and the rear housing 30 can be sequentially connected to form a receiving cavity 80 (shown in FIG. 16).

The front housing 10 includes a front housing top wall 11, a front housing bottom wall 12 opposite to the front housing top wall 11, two front housing side walls 13 connected to the front housing top wall 11 and the front housing bottom wall 12 and disposed opposite to each other, a front housing front wall 17 connected to the two front housing side walls 13, a front housing rear wall 18 opposite to the front housing front wall 17. The two front housing side walls 13 includes a first front housing side wall 131 and a second front housing side wall 132.

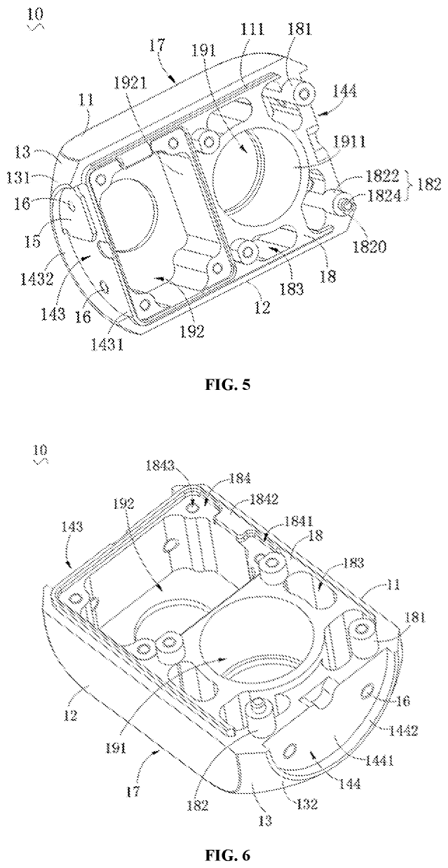

Referring to FIG. 5 to FIG. 7, each front housing side wall 13 includes a front housing groove 14. More specifically, a first front housing groove 143 is disposed on the first front housing side wall 131, and a second front housing groove 144 is disposed on the second front housing side wall 132. A front housing protrusion 15 is formed on a bottom surface 141 of at least one front housing groove 14. More specifically, the front housing protrusion 15 may be formed on a bottom surface 1431 of the first front housing groove 143, the front housing protrusion 15 may be formed on a bottom surface 1441 of the second front housing groove 144, or the front housing protrusion 15 may be formed on both the bottom surface 1431 of the first front housing groove 143 and the bottom surface 1441 of the second front housing groove 144. The front housing protrusion 15 can act as a counterweight, which is beneficial to make the center of gravity of the input and output component 100 and the inner frame of the gimbal 200 equipped with the input and output component 100 to be on the axis of the pitch axis of the gimbal 200 (shown in FIG. 19).

In some embodiments, when the front housing protrusion 15 is formed on both the bottom surface 1431 of the first front housing groove 143 and the bottom surface 1441 of the second front housing groove 144, the front housing protrusion 15 on the first front housing groove 143 may be different from the front housing protrusion 15 on the second front housing groove 144, and the different front housing protrusions 15 can play a role of fool-proofing. The difference here may be the difference in shape and size of the front housing protrusion 15 on the first front housing groove 143 and the front housing protrusion 15 on the second front housing groove 144, or the difference in the position relative to the center of the bottom surface 1431 or the center of the bottom surface 1441.

The bottom surface 141 of each front housing groove 14 includes a front housing mounting part 16. More specifically, the front housing mounting part 16 may be disposed on both the bottom surface 1431 of the first front housing groove 143 and the bottom surface 1441 of the second front housing groove 144. In some embodiments, there may be a plurality of front housing mounting parts 16 disposed on the bottom surface 141 of each front housing groove 14. Part of the front housing mounting parts 16 may be disposed on the front housing protrusion 15, and the remaining front housing mounting parts 16 may be disposed on the bottom surface 141 of the front housing groove 14 except the front housing protrusion 15. In this embodiment, there are two front housing mounting parts 16 disposed on the bottom surface 141 of each front housing groove 14, and the front housing mounting parts 16 are screw locking holes.

The front housing rear wall 18 is positioned in the receiving cavity 80. The front housing rear wall 18 is recessed toward the front housing front wall 17 to form a storage space 19, and the storage space 19 includes a first storage space 191 and a second storage space 192. Two or more input and output modules 40 may partially extend into the first storage space 191 and/or the second storage space 192. More specifically, the front housing rear wall 18 may be recessed toward the front housing front wall 17 to form a plurality of first storage spaces 191, and the plurality of first storage spaces 191 may be arranged at intervals; or the front housing rear wall 18 may be recessed toward the front housing front wall 17 to form a plurality of second storage spaces 192, and the plurality of second storage spaces 192 may be arranged at intervals; or the front housing rear wall 18 may be recessed toward the front housing front wall 17 to form one or more first storage spaces 191 and one or more second storage spaces 192, and the one or more first storage spaces 191 and one or more second storage spaces 192 may be arranged at intervals.

Referring to FIG. 5 to FIG. 7, when the front housing 10 includes the first storage space 191, the front housing 10 further includes a first coupling member 181 and a first positioning member 182 disposed on the front housing rear wall 18. The first coupling member 181 can be used to fix the input and output module 40 partially extending into the first storage space 191 on the front housing 10, and the first positioning member 182 can be used to position the input and output module 40 partially extending into the first storage space 191. In some embodiments, there may be one or more first positioning members 182, and there may be two or more first coupling members 181. The one or more first positioning members 182 and the two or more first coupling members 181 can be evenly distributed on the front housing rear wall 18 around the first storage space 191.

In some embodiments, the first coupling member 181 may be an engaging post extending from the front housing rear wall 18. The shape of the engaging post may be any of a cylinder, a triangular prism, a cube, a cuboid, and a polygonal prism. In other embodiments, the first coupling member 181 may also be an engaging hole (not shown in the accompanying drawings) disposed on the front housing rear wall 18, and the shape of the engaging hole may be any of a circle, a triangle, a square, a rectangle, or a polygon. Alternatively, the first coupling member 181 may also include a cylinder having a threaded hole and a screw extending from the front housing rear wall 18.

In some embodiments, the first positioning member 182 includes an extension post 1822 extending from the front housing rear wall 18 and an engaging post 1824 extending from a top surface 1820 of the extension post 1822. The shape of the extension post 1822 may be any of a cylinder, a triangular prism, a cube, a cuboid, and a polygonal prism, and the shape of the engaging post 1824 may be any of a cylinder, a triangular prism, a cube, a cuboid, and a polygonal prism. In other embodiments, the first positioning member 182 may also be a positioning hole (not shown in the accompanying drawings) disposed on the front housing rear wall 18, and the shape of the positioning hole may be any of a circle, a triangle, a square, a rectangle, or a polygon.

In some embodiments, when the front housing 10 includes the first storage space 191, a weight reduction groove 183 is also disposed on the front housing 10. A plurality of weight reduction grooves 183 may be evenly distributed on the front housing rear wall 18. In this embodiment, there are two weight reduction grooves 183, and the two weight reduction grooves 183 are symmetrically distributed on both sides of the first storage space 191. The weight reduction groove 183 may be a through groove or a blind groove, which is not limited in the embodiments of the present disclosure. On one hand, the weight reduction groove 183 can reduce the weight of the input and output component 100, which is convenient for the gimbal 200 to control the input and output component 100. On the other hand, the weight reduction groove 183 save materials and reduce costs.

Referring to FIG. 5 to FIG. 7, when the front housing 10 includes the second storage space 192, the front housing rear wall 18 is recessed toward the front housing front wall 17 to form a positioning groove 184, which can be used to position the input and output module 40 partially extending into the second storage space 192. The positioning groove 184 includes a second storage space 192, that is, the second storage space 192 is opened on a bottom surface 1841 of the positioning groove 184. A protrusion 1842 is disposed on the bottom surface 1841 of the positioning groove 184, and a screw hole 1843 is opened on the bottom surface 1841 of the positioning groove 184. The protrusion 1842 can play a role of fool-proofing.

In some embodiments, the first coupling members 181 may also be distributed on the front housing rear wall 18 around the second storage space 192, and there may be two or more first coupling members 181 distributed around the second storage space 192. The first coupling member 181 may be an engaging post extending from the front housing rear wall 18, or an engaging hole opened on the front housing rear wall 18, or a cylinder with a threaded hole and a screw extending from the front housing rear wall 18.

Referring to FIG. 5 to FIG. 8, a light-transmitting area 171 is formed on the front housing front wall 17. The light-transmitting area 171 corresponds to the first storage space 191 and/or the second storage space 192. In some embodiments, the light-transmitting area 171 includes a light-transmitting hole 172 communicating with the first storage space 191 and/or the second storage space 192. More specifically, when the front housing 10 includes a plurality of first storage spaces 191, there may be a plurality of light-transmitting holes 172, and the plurality of light-transmitting holes 172 may correspond to the plurality of first storage spaces 191 with a one-to-one correspondence. Further, when the front housing 10 includes a plurality of second storage spaces 192, there may be a plurality of light-transmitting holes 172, and the plurality of light-transmitting holes 172 may correspond to the plurality of second storage spaces 192 with a one-to-one correspondence. Furthermore, when the front housing 10 includes one or more first storage spaces 191 and one or more second storage spaces 192, there may be two or more light-transmitting holes 172, and the two or more light-transmitting holes 172 may correspond to the one or more first storage spaces 191 and the one or more second storage spaces 192 with a one-to-one correspondence.

In some embodiments, the input and output component 100 further includes a transparent lens 70. The transparent lens 70 may be sealed in the light-transmitting hole 172, such that the light signal can pass through the transparent lens 70. In other embodiments, the input and output component 100 further includes a transparent lens 70 and a cover 90. The outer contour of the cover 90 may match the contour of the groove where the light-transmitting area 171 is positioned. The cover 90 may include a light-passing hole, and the light-passing hole may correspond to the first storage space 191 and/or the second storage space 192. When the cover 90 is installed on the front housing front wall 17, the cover 90 may complete cover the groove where the light-transmitting area 171 is positioned. The transparent lens 70 may be sealed in the light-passing hole, and the light signal may pass through the transparent lens 70. In some embodiments, the front housing front wall 17 may be formed by two-color molding, the light-transmitting area 171 may be made of light-transmitting material, and the area of the front housing front wall 17 excluding the light-transmitting area 171 may be made of non-light-transmitting material. In this way, the light signal may only pass through the light-transmitting area 171.

Referring to FIG. 2 to FIG. 4 and FIG. 9 to FIG. 11, the middle housing 20 is a hollow structure. The middle housing 20 includes a middle housing top wall 23, a middle housing bottom wall 24 opposite to the middle housing top wall 23, two middle housing side walls 25 connected to the middle housing top wall 23 and the middle housing bottom wall 24, and opposite to each other, and two opposite first ends 21 and second ends 22. The middle housing side walls 25 includes a first middle housing side wall 251 and a second middle housing side wall 252. The middle housing 20 can be used to connect with the gimbal 200 (shown in FIG. 19). The first ends 21 of the middle housing 20 is connected to the front housing 10, and the second ends 22 of the middle housing 20 is connected to the a rear housing 30.

When the front housing 10 is connected to the first ends 21 of the middle housing 20, the front housing top wall 11 may abut against the first end 21 of the middle housing top wall 23, and the front housing bottom wall 12 may abut against the first end 21 of the middle housing bottom wall 24. More specifically, a first boss 111 is disposed on the edge of the front housing top wall 11 facing the middle housing 20 and the edge of the front housing bottom wall 12 facing the middle housing 20. The first end 21 of the middle housing top wall 23 bears against the first boss 111 of the front housing top wall 11, and the first boss 111 of the front housing bottom wall 12 bears against the first end 21 of the middle housing top wall 23. The first bosses 111 on the front housing top wall 11 and the front housing bottom wall 12 can play a role on limiting the position between the front housing 10 and the middle housing 20, thereby facilitating the installation of the front housing 10 and the middle housing 20. At the same time, by using the first boss 111, the tightness of the connection between the front housing top wall 11 and the first end 21 of the middle housing top wall 23, and the front housing bottom wall 12 and the first end 21 of the middle housing bottom wall 24 can be improved, the gap can be reduced, thereby reducing the possibility of moisture, dust, etc. from entering the receiving cavity 80.

The first ends 21 of the two middle housing side walls 25 can be received in the front housing groove 14, and an end surface 211 of the first end 21 of each middle housing side wall 25 can be attached to the corresponding side surface 142 of the front housing groove 14. More specifically, the first end 21 of the first middle housing side wall 251 can be received in the first front housing groove 143, and the end surface 211 of the first end 21 of the first middle housing side wall 251 can be attached to a side surface 1432 of the first front housing groove 143. The first end 21 of the second middle housing side wall 252 can be received in the second front housing groove 144, and the end surface 211 of the first end 21 of the second middle housing side wall 252 can be attached to a side surface 1442 of the second front housing groove 144.

In some embodiments, the middle housing side wall 25 may have a racetrack shape. The end surface 211 of the first end 21 of the first middle housing side wall 251 may have an arc surface, and correspondingly, the side surface 1432 of the first front housing groove 143 may also have an arc surface. The end surface 211 of the first end 21 of the second middle housing side wall 252 may have an arc surface, and correspondingly, the side surface 1442 of the second front housing groove 144 may also have an arc surface. When the front housing 10 is connected to the first end 21 of the middle housing 20, the arc surface (end surface 211) of the first end 21 of the first middle housing side wall 251 and the arc surface (side surface 1432) of the first front housing groove 143 may be attached to each other; and the arc surface (end surface 211) of the first end 21 of the second middle housing side wall 252 and the arc surface (side surface 1442) of the second front housing groove 144 may be attached to each other. In some embodiments, the arc surface may be a semi-circular arc surface, a third arc surface, a quarter arc surface, etc. Of course, in other embodiments, the middle housing 20 may also have a square shape, a rectangular shape, a combination of a square and a semi-circle, a combination of a rectangle and a semi-circle, etc. For example, when the main body formed by the middle housing top wall 23 and the middle housing bottom wall 24 in the middle housing 20 is rectangular, the end surface 211 of the first end 21 of the middle housing side wall 25 may have a U-shaped surface. Correspondingly, the side surface 142 of the front housing groove 14 may also have a U-shaped surface, and the U-shaped surface of the first end 21 of the middle housing side wall 25 may be attached to the U-shaped surface of the front housing groove 14. In another example, one end of the middle housing 20 may be rectangular, and the other end may be semi-circular. At this time, the end surface 211 of the first end 21 of the middle housing side wall 25 may be a semi-circular arc surface or a U-shaped surface. If the end surface 211 of the first end 21 of the middle housing side wall 25 is a semi-circular arc surface, the side surface 142 of the front housing groove 14 may also be a semi-circular arc surface; and if the end surface 211 of the first end 21 of the middle housing side wall 25 is a U-shaped surface, the side surface 142 of the front housing groove 14 may also be a U-shaped surface. By using the above design, the front housing 10 and the middle housing 20 can be partially overlapped in space. While fixing the front housing 10 and the middle housing 20, the length of the input and output component 100 can be reduced, which is beneficial to the miniaturization design, and the integration on a small gimbal, such as the gimbal 200.

When the front housing protrusion 15 is formed on the bottom surface 141 of at least one front housing groove 14, a first groove 261 may be correspondingly formed on the first end 21 of the at least one middle housing side wall 25. More specifically, if the bottom surface 1431 of the first front housing groove 143 is formed with a front housing protrusion 15, the first end 21 of the first middle housing side wall 251 may be formed with a first groove 261. When the front housing 10 is connected to the first end 21 of the middle housing 20, the front housing protrusion 15 of the first front housing groove 143 may be matched with the first groove 261 of the first middle housing side wall 251. If the bottom surface 1441 of the second front housing groove 144 is formed with a front housing protrusion 15, the first end 21 of the second middle housing side wall 252 may be formed with a first groove 261. When the front housing 10 is connected to the first end 21 of the middle housing 20, the front housing protrusion 15 of the second front housing groove 144 may be matched with the first groove 261 of the second middle housing side wall 252. If the bottom surface 1431 of the first front housing groove 143 and the bottom surface 1441 of the second front housing groove 144 are both formed with the front housing protrusions 15, then the first end 21 of the first middle housing side wall 251 and the first end 21 of the second middle housing side wall 252 may be both formed with a first groove 261. When the front housing 10 is connected to the first ends 21 of the middle housing 20, the front housing protrusion 15 of the first front housing groove 143 may be matched with the first groove 261 of the first middle housing side wall 251, and the front housing protrusion 15 of the second front housing groove 144 may be matched with the first groove 261 of the second middle housing side wall 252. The cooperation between the front housing protrusion 15 and the first groove 261 can play a role in positioning the position between the front housing 10 and the middle housing 20. At the same time, the front housing protrusion 15 on the first front housing groove 143 may be different from the front housing protrusion 15 on the second front housing groove 144, which can play a role of fool-proofing. That is, when the middle housing 20 and the front housing 10 are being installed, the middle housing top wall 23 and the middle housing bottom wall 24 can be prevented from being reversed, and the first middle housing side wall 251 and the second middle housing side wall 252 can also be prevented from being reversed.

The first end 21 of each middle housing side wall 25 may include a first end mounting part 2611. More specifically, both the first end 21 of the first middle housing side wall 251 and the first end 21 of the second middle housing side wall 252 may be provided with a first end mounting part 2611. The first end mounting part 2611 and the front housing mounting part 16 may match and lock to connect the front housing 10 with the first ends 21 of the middle housing side walls 25. In some embodiments, a plurality of first end mounting parts 2611 may be disposed on the first end 21 of each middle housing side wall 25. Part of the plurality of first end mounting parts 2611 may be disposed in the first groove 261. The first end mounting parts 2611 disposed in the first groove 261 may be locked with the front housing mounting part 16 disposed on the front housing protrusion 15. The remaining first end mounting parts 2611 may be disposed at a position other than the first groove 261 of the first end 21 of the middle housing side wall 25. The first end mounting parts 2611 disposed at a position other than the first groove 261 may be locked with the front housing mounting part 16 disposed at a position other than the front housing protrusion 15. In this embodiment, the first end mounting part 2611 is a threaded mounting hole, and the front housing mounting part 16 is a threaded locking hole. When the first end mounting part 2611 is matched with the front housing mounting part 16, the screw passes through the mounting hole and is locked in the locking hole to connect the front housing 10 with the first end 21 of the middle housing side wall 25.

In some embodiments, a second groove 262 may be formed at the second end 22 of at least one middle housing side wall 25. More specifically, the second end 22 of the first middle housing side wall 251 may be formed with the second groove 262, or the second end 22 of the second middle housing side wall 252 may be formed with the second groove 262, or the second end 22 of the first middle housing side wall 251 and the second end 22 of the second middle housing side wall 252 may both be formed with a second groove 262.

A second end mounting part 2621 may be disposed at the second end 22 of the middle housing side wall 25. More specifically, the second end 22 of the first middle housing side wall 251 and the second end 22 of the second middle housing side wall 252 may both be provided with a second end mounting part 2621. In one example, a plurality of second end mounting parts 2621 can be disposed on the second end 22 of each middle housing side wall 25. Part of the plurality of second end mounting parts 2621 may be disposed in the second groove 262, and the remaining second end mounting parts 2621 may be disposed at a position other than the second groove 262 of the second end 22 of the middle housing side wall 25. In this embodiment, the second end mounting part 2621 is a threaded mounting hole.

A wiring hole 35 may be disposed on the middle housing side wall 25 for wires to go through. More specifically, the wiring hole 35 can be opened on the second middle housing side wall 252.

A middle housing convex ring 28 (i.e., the connecting part) may be disposed on the first middle housing side wall 251. More specifically, an escape hole 27 may be disposed on the middle housing convex ring 28. That is, the middle housing convex ring 28 can be disposed around the escape hole 27. In some embodiments, a driving device of the gimbal 200 may be connected to the middle housing convex ring 28 to realize a fixed connected between the rotation shaft of the driving device and the input and output component 100, and the escape hole 27 may be used to avoid the driving shaft of the driving device of the gimbal 200.

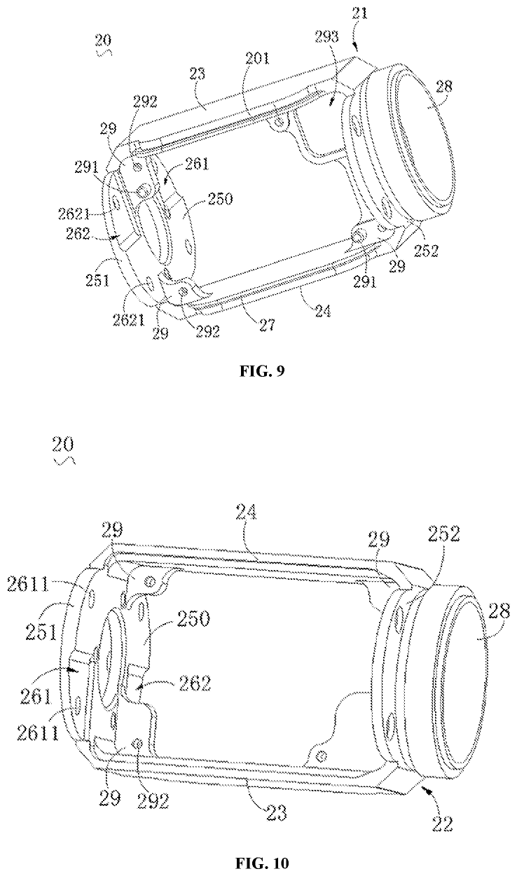

Referring to FIG. 4, FIG. 9, FIG. 10, and FIG. 16, the middle housing 20 further includes a partition wall 29. The partition wall 29 is received in the receiving cavity 80 and extends from an inner surface 250 of the middle housing side wall 25. The partition wall 29 divides the receiving cavity 80 into a first sub-receiving cavity 81 and a second sub-receiving cavity 82. There may be two or more partition walls 29, that is, the number of partition walls 29 may be two, three, four, or more. Two or more partition walls 29 are can be distributed on the inner surface 250 of the middle housing side wall 25 at intervals. A first positioning mechanism 291 can be disposed on any one of the two or more partition walls 29, and a first connection mechanism 292 can be disposed on the two or more partition walls 29. In this embodiment, there are four partition walls 29. Two of the partition walls 29 are distributed on the inner surface 250 of the first middle housing side wall 251, and the other two partition walls 29 are distributed on the inner surface 250 of the second middle housing side wall 252. One of the two partition walls 29 distributed on the same middle housing side wall 25 is connected with the middle housing top wall 23, and the other partition wall 29 is connected with the middle housing bottom wall 24. There are two first positioning mechanisms 291. One of the first positioning mechanism 291 is positioned on the partition wall 29 of the first middle housing side wall 251 connected to the middle housing top wall 23, and the other first positioning mechanism 291 is positioned on the partition wall 29 of the second middle housing side wall 252 connected to the middle housing bottom wall 24. There are four first connection mechanisms 292, which are respectively positioned on the four partition walls 29.

In some embodiments, the first positioning mechanism 291 may include an extension post extending from the partition wall 29 and an engaging post extending from the top surface of the extension post. The shape of the extension post may be any of a cylinder, a triangular prism, a cube, a cuboid, and a polygonal prism, and the shape of the engaging post may be any of a cylinder, a triangular prism, a cube, a cuboid, and a polygonal prism. In other embodiments, the first positioning mechanism 291 may also be a positioning hole (not shown in the accompanying drawings) disposed on the partition wall 29, and the shape of the positioning hole may be any of a circle, a triangle, a square, a rectangle, or a polygon.

In some embodiments, the first connection mechanism 292 may be an engaging post extending from the partition wall 29. The shape of the engaging post may be any of a cylinder, a triangular prism, a cube, a cuboid, and a polygonal prism. In other embodiments, the first connection mechanism 292 may also be an engaging hole (not shown in the accompanying drawings) disposed on the front housing rear wall 18, and the shape of the engaging hole may be any of a circle, a triangle, a square, a rectangle, or a polygon. Alternatively, the first connection mechanism 292 may also include a cylinder having a threaded hole and a screw extending from the partition wall 29. In this embodiment, the first connection mechanism 292 is an installation hole with threads.

A receiving groove 293 can be disposed on one or more partition walls 29. In this embodiment, the receiving groove 293 is disposed on the partition wall 29 distributed on the second middle housing side wall 252 and connected with the middle housing top wall 23. In some embodiments, the receiving groove 293 may be filled with a damping material to reduce the disturbance of some components (e.g., an inertial measurement unit) on the main board 60.

Referring to FIG. 2 to FIG. 4, the rear housing 30 includes a rear housing top wall 31, a rear housing bottom wall 32 opposite to the rear housing top wall 31, two rear housing side walls 33 connected to the rear housing top wall 31 and the rear housing bottom wall 32. The two rear housing side walls 33 includes a first rear housing side wall 331 and a second rear housing side wall 332, respectively.

When the rear housing 30 is connected to the second ends 22 of the middle housing 20, the rear housing top wall 31 abuts against the second end 22 of the middle housing top wall 23, and the rear housing bottom wall 32 abuts against the second end 22 of the middle housing bottom wall 24. More specifically, a second boss 201 is disposed at the edge of the second end 22 of the middle housing top wall 23 and the edge of the second end 22 of the middle housing bottom wall 24. The rear housing top wall 31 bears on the second boss 201 of the middle housing top wall 23, and the second boss 201 of the middle housing bottom wall 24 bears on the rear housing bottom wall 32. The second boss 201 can play a role of fool-proofing and facilitate the installation of the middle housing 20 and the rear housing 30. In addition, compared with not using the second boss 201, where the rear housing top wall 31 directly abuts against the second end 22 of the middle housing top wall 23, and the rear housing bottom wall 32 directly abuts against the second end 22 of the middle housing bottom wall 24, after installing the second boss 201, the second boss 201 can prevent the gap between the rear housing top wall 31 and the middle housing top wall 23, and the gap between the rear housing bottom wall 32 and the second end 22 of the middle housing bottom wall 24 from directly communicating with the receiving cavity 80. In a dusty environment, most of the dust can be blocked to prevent the dust from entering the receiving cavity 80.

A rear housing groove 34 is disposed on each rear housing side wall 33. More specifically, a first rear housing groove 341 is disposed on the first rear housing side wall 331, and a second rear housing groove 342 is disposed on the second rear housing side wall 332. When the rear housing 30 is connected to the second ends 22 of the middle housing side wall 25, the second ends 22 of the two middle housing side walls 25 are received in the rear housing groove 34, and the end surface 221 of the second end 22 of each middle housing side wall 25 is attached to a side surface 3401 of the corresponding rear housing groove 34. More specifically, the second end 22 of the first middle housing side wall 251 is received in the in the first rear housing groove 341, and an end surface 221 of the second end 22 of the first middle housing side wall 251 is attached to the side surface 3401 of the first rear housing groove 341. The second end 22 of the second middle housing side wall 252 is received in the second rear housing groove 342, and the end surface 221 of the second end 22 of the second middle housing side wall 252 is attached to the side surface 3401 of the second rear housing groove 342.

The end surface 221 of the second end 22 of the first middle housing side wall 251 is an arc surface, and correspondingly, the side surface 3401 of the first rear housing groove 341 is also an arc surface. The end surface 221 of the second end 22 of the second middle housing side wall 252 is an arc surface, and correspondingly, the side surface 3401 of the second rear housing groove 342 is also an arc surface. When the rear housing 30 is connected to the second ends 22 of the middle housing 20, the arc surface of the first middle housing side wall 251 is attached to the arc surface of the first rear housing groove 341, and the arc surface of the second middle housing side wall 252 is attached to the arc surface of the second rear housing groove 342. In some embodiments, the arc surface may be a semi-circular arc surface, a third arc surface, a quarter arc surface, etc. Of course, in other embodiments, when the main body formed by the middle housing top wall 23 and the middle housing bottom wall 24 of the middle housing 20 is rectangular, the end surface 221 of the second end 22 of the middle housing side wall 25 may have a U-shaped surface. Correspondingly, the side surface 3401 of the rear housing groove 34 may also have a U-shaped surface, and the U-shaped surface of the second end 22 of the middle housing side wall 25 may be attached to the U-shaped surface of the rear housing groove 34. In another example, one end of the middle housing 20 may be rectangular, and the other end may be semi-circular. At this time, if the end surface 221 of the second end 22 of the middle housing side wall 25 is a semi-circular arc surface, the side surface 3401 of the rear housing groove 34 may also be a semi-circular arc surface; and if the end surface 221 of the second end 22 of the middle housing side wall 25 is a U-shaped surface, the side surface 3401 of the rear housing groove 34 may also be a U-shaped surface. By using the above design, the rear housing 30 and the middle housing 20 can be partially overlapped in space. While fixing the rear housing 30 and the middle housing 20, the length of the input and output component 100 can be reduced, which is beneficial to the miniaturization design, and the integration on a small gimbal, such as the gimbal 200.

A rear housing notch 343 is disposed on a bottom surface 3402 of each rear housing groove 34. More specifically, the rear housing notch 343 is disposed on both the bottom surface 3402 of the first rear housing groove 341 and the bottom surface 3402 of the second rear housing groove 342. The rear housing notch 343 can act as a counterweight to balance the weight of the front housing 10 and the rear housing 30, which is beneficial to make the center of gravity of the input and output component 100 and the inner frame of the gimbal 200 equipped with the input and output component 100 to be on the axis of the pitch axis of the gimbal 200.

A rear housing protrusion 344 is formed on the bottom surface 3402 of the rear housing groove 34 of at least one rear housing side wall 33 on the side of the rear housing notch 343. More specifically, the rear housing protrusion 344 may be formed on the bottom surface 3402 of the first rear housing groove 341 at a position on one side of the rear housing notch 343. At this time, the second groove 262 can be formed on the second end 22 of the first middle housing side wall 251. When the rear housing 30 is connected to the second end 22 of the middle housing 20, the rear housing protrusion 344 of the first rear housing groove 341 may be attached to the second groove 262 of the first middle housing side wall 251. The rear housing protrusion 344 may also be formed on the bottom surface 3402 of the second rear housing groove 342 on one side of the rear housing notch 343. At this time, the second groove 262 can be formed on the second end 22 of the second middle housing side wall 252. When the rear housing 30 is connected to the second end 22 of the middle housing 20, the rear housing protrusion 344 of the second rear housing groove 342 may be attached to the second groove 262 of the second middle housing side wall 252. The rear housing protrusion 344 may also be formed on the bottom surface 3402 of the first rear housing groove 341 and the bottom surface 3402 of the second rear housing groove 342 on one side of the rear housing notch 343. At this time, the second end 22 of the first middle housing side wall 251 and the second end 22 of the second middle housing side wall 252 may both be formed with a second groove 262. When the rear housing 30 is connected to the second end 22 of the middle housing 20, the rear housing protrusion 344 of the first rear housing groove 341 may be attached to the second groove 262 of the first middle housing side wall 251, and the rear housing protrusion 344 of the second rear housing groove 342 may be attached to the second groove 262 of the second middle housing side wall 252. The cooperation between the rear housing protrusion 344 and the second groove 262 can play a role in positioning the rear housing 30 and the middle housing 20.

In one example, when the bottom surface 3402 of the first rear housing groove 341 and the bottom surface 3402 of the second rear housing groove 342 are formed with the rear housing protrusions 344 on one side of the rear housing notch 343, the rear housing protrusion 344 on the first rear housing groove 341 may be different from the rear housing protrusion 344 on the second rear housing groove 342, and the rear housing protrusions 344 with different shapes can play a role of fool-proofing. That is, when the middle housing 20 and the rear housing 30 are installed, the middle housing top wall 23 and the middle housing bottom wall 24 can be prevented from being reversed, and the first middle housing side wall 251 and the second middle housing side wall 252 can also be prevented from being reversed. The difference here may be the difference in shape and size of the rear housing notch 343 on the first rear housing groove 341 and the rear housing notch 343 on the rear housing protrusion 344, or the difference in the positions relative to the center of the bottom surface 3402 of the first rear housing groove 341 and the bottom surface 3402 of the second rear housing groove 342.

A rear housing mounting part 345 is disposed on the bottom surface 3402 of each rear housing groove 34. More specifically, the rear housing mounting part 345 is disposed on both the bottom surface 3402 of the first rear housing groove 341 and the bottom surface 3402 of the second rear housing groove 342. In some embodiments, there may be a plurality of rear housing mounting parts 345 disposed on the bottom surface 3402 of each rear housing groove 34. Part of the plurality of rear housing mounting parts 345 may be disposed on the rear housing protrusion 344, and the rear housing mounting parts 345 disposed on the rear housing protrusion 344 may match and lock with the second end mounting part 2621 provided on the second groove 262. The remaining rear housing mounting parts 345 may be disposed on the rear housing groove 34 except the rear housing protrusion 344, and the rear housing mounting parts 345 disposed on the rear housing groove 34 except the rear housing protrusion 344 may match and lock with the second end mounting part 2621 disposed at a position other than the second groove 262. In this embodiment, the rear housing mounting part 345 is a threaded locking hole, and the second end mounting part 2621 is a threaded mounting hole. When the second end mounting part 2621 is matched with the rear housing mounting part 345, the screw passes through the mounting hole and is locked in the locking hole to connect the rear housing 30 with the second end 22 of the middle housing side wall 25.

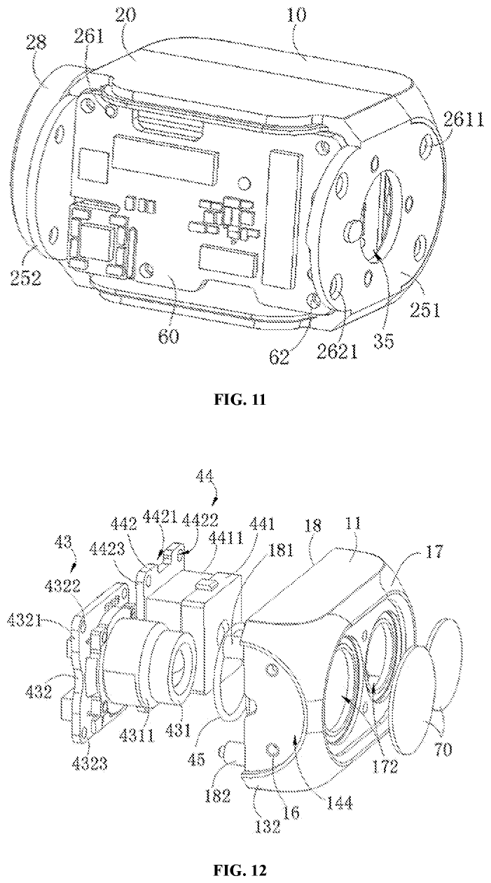

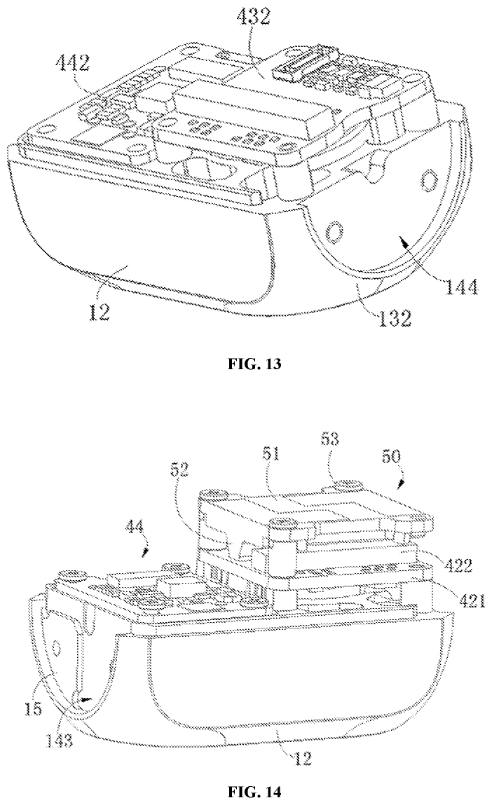

Referring to FIG. 2 to FIG. 4, and FIG. 12 to FIG. 13, the input and output module 40 includes a circuit board 42 and a module body 41. The circuit board 42 includes a substrate 421 and electronic components 422 disposed on the substrate.

A plurality of input and output modules 40 can be disposed between the front housing 10 and the middle housing 20, installed on the front housing 10 and/or the middle housing 20, and received in the first sub-receiving cavity 81. More specifically, take two input and output modules 40 as an example, both input and output modules 40 may be installed only on the front housing 10; or, both input and output modules 40 may be installed only on the middle housing 20; or, the two input and output modules 40 may be installed on the front housing 10 and the middle housing 20 at the same time; or, one of the two input and output modules 40 may only be installed on the front housing 10, and the other may only be installed on the middle housing 20; or, one of the two input and output modules 40 may only be installed on the front housing 10, and the other may be installed on the front housing 10 and the middle housing 20 at the same time; or, one of the two input and output modules 40 may only be installed on the middle housing 20, and the other may be installed on the front housing 10 and the middle housing 20 at the same time.

The plurality of input and output modules 40 may be light emitting modules and/or imaging modules. More specifically, the plurality of input and output modules 40 may all be light emitting modules; or, the plurality of input and output modules 40 may all be imaging modules; or, part of the input and output modules 40 may be light emitting modules, and part of the input and output modules 40 may be imaging modules. When the input and output module 40 is an imaging module, the input and output module 40 may receive a first light signal from the outside through the front housing 10. When the input and output module 40 is a light emitting module, the input and output module 40 may emit a second light signal passing through front housing 10 to the outside.

In some embodiments, the imaging module may include any one or more of a visible light camera module, a thermal imaging camera module, an infrared light camera module, and a time-of-flight camera module; and, the light emitting modules may include any one or more of a fill light, a radar, a time-of-flight projector, and a structured light projector. For example, if the two input and output modules 40 are both imaging modules, then the two input and output modules 40 may both be the visible light camera modules. In this case, the two visible light camera modules can be used as binocular cameras to measure the depth information of the scene. In another example, the two input and output modules 40 are both imaging modules, one of the two input and output modules 40 may be a visible light camera module, and the other may be a thermal imaging camera module. At this time, the input and output component 100 composed of the two input and output modules 40, the front housing 10, the middle housing 20, the rear housing 30, and other components may be a dual-vision camera. The dual-vision camera can be used in application scenarios such as forest fire prevention and car chasing at night through two sensors. In another example, if one of the two input and output modules 40 is an imaging module, and the other is a light emitting module, then the input and output module 40 as the imaging module may be an infrared camera, and the input and output module 40 as the light emitting module may be a structured light projector. At this time, the infrared camera and the structured light project can form a structured light depth camera to measure the depth information of the scene. In another example, if the two input and output modules 40 are both light emitting modules, one of the two input and output modules 40 may be a visible light supplementary light, and the other input and output module 40 may be an infrared supplementary light. At this time, the two input and output modules 40 can form a fill light component, which can be used for fill light in dark shooting scenes. Of course, the combination of the input and output modules 40 listed above is merely an example, and should not be understood at a limitation to the embodiments of the present disclosure.

In actual use, users can replace the input and output module 40 in the input and output component 100 based on needs. For example, the input and output component 100 may be originally a dual-vision camera, one of the input and output modules 40 in the input and output component 100 may be a visible light camera module, and the other input and output module 40 may be a thermal imaging camera module. The user may replace the thermal imaging camera module with a visible light camera module. At this time, the input and output component 100 becomes a binocular camera, and the binocular camera can be used to measure the depth of the scene. In this way, the input and output component 100 can be applied to a variety of application scenarios, and meet the multiple user requirements of users.

In some embodiments, the plurality of input and output modules 40 may include one or more first input and output modules 43 and one or more second input and output modules 44 (when the plurality of input and output modules 40 are imaging modules, the first input and output module 43 may be the first camera module 43, and the second input and output module 44 may be the second camera module 44, for example, when the input and output component 100 is a dual-vision camera, the first camera module 43 may be a visible light camera module, and the second camera module 44 may be a thermal imaging camera module). When there is one first input and output module 43, the first input and output module 43 may be an imaging module or a light emitting module. When there are a plurality of first input and output modules 43, the first input and output modules 43 may be all imaging modules, all light emitting modules, or a mix of imaging modules and light emitting modules. Similarly, when there is one second input and output module 44, the second input and output module 44 may be an imaging module or a light emitting module. When there are a plurality of second input and output modules 44, the second input and output modules 44 may be all imaging modules, all light emitting modules, or a mix of imaging modules and light emitting modules

Referring to FIG. 2 and FIG. 12, the first input and output module 43 includes a first circuit board 432 and a first module body 431. The first circuit board 432 is installed on the front housing rear wall 18 and/or the middle housing 20, and the first module body 431 extends into the first storage space 191 and is aligned with the light-transmitting area 171. The size of the first storage space 191 may be slightly larger than the size of the first module body 431, and the contour of the first storage space 191 may match the contour of the first module body 431. In this way, when the first module body 431 extends into the first storage space 191, the first storage space 191 can serve the function of positioning the first module body 431.

A second coupling member 4322 and a second positioning member 4323 are disposed on the first circuit board 432. In some embodiments, the number of the second coupling member 4322 may be equal to the number of the first coupling member 181, and the number of the second positioning member 4323 may be equal to the number of the first positioning member 182. The second coupling member 4322 and the first coupling member 181 can cooperate and lock to fix the first circuit board 432 on the front housing rear wall 18. The second positioning member 4323 and the first positioning member 182 may cooperate to position in the first circuit board 432 on the front housing rear wall 18.

In some embodiments, the second coupling member 4322 may be an engaging hole disposed on the first circuit board 432. Correspondingly, the first coupling member 181 may be an engaging post (not shown in the accompanying drawings) extending from the front housing rear wall 18. When the second coupling member 4322 and the first coupling member 181 cooperate, the engaging hole may be engaged with the engaging post. In other embodiments, the second coupling member 4322 may also be an engaging post extending from the first circuit board 432. Correspondingly, the first coupling member 181 may be an engaging hole (not shown in the accompanying drawings) disposed on the front housing rear wall 18. When the second coupling member 4322 and the first coupling member 181 cooperate, the engaging hole may be engaged with the engaging post. In this embodiment, the second coupling member 4322 is a through hole opened on the first circuit board 432. Correspondingly, the first coupling member 181 includes a cylinder extending from the front housing rear wall 18 having a threaded hole and a screw. When the second coupling member 4322 and the first coupling member 181 cooperate, the screw passes through the through hole and is screwed into the threaded hole. When the second coupling member 4322 is an engaging post extending from the first circuit board 432, and the first coupling member 181 is an engaging hole opened on the front housing rear wall 18, the shape of the engaging post may be any of a cylinder, a triangular prism, a cube, a cuboid, and a polygonal column, and the shape of the engaging hole may be any of a circle, a triangle, a square, a rectangle, and a polygon. For example, when the shape of the engaging post is cylindrical, the shape of the engaging hole should be circular; when the shape of the engaging post is a triangular prism, the shape of the engaging hole should be triangular; when the shape of the engaging post is a cuboid, the shape of the engaging hole should be a rectangle. The shape matching of the engaging post and the engaging hole listed above is merely an example, and should not be understood as a limitation to the embodiments of the present disclosure.

In some embodiments, the second positioning member 4323 may be a positioning hole opened on the first circuit board 432. Correspondingly, the first positioning member 182 may include an extension post 1822 (shown in FIG. 5) extending from the front housing rear wall 18 and a locking column 1824 extending from the top surface 1820 of the extension post 1822. When the second positioning member 4323 cooperates with the first positioning member 182, the first circuit board 432 can be carried on the top surface 1820 of the extension post 1822, and the locking column 1824 can pass through the positioning hole such that the first circuit board 432 can be installed on the front housing rear wall 18. In other embodiments, the second positioning member 4323 may further include an extension post extending from the first circuit board 432 and a locking column extending from the top surface of the extension post. Correspondingly, the first positioning member 182 may be a positioning hole (not shown in the accompanying drawings) opened on the front housing rear wall 18. When the second positioning member 4323 cooperates with the first positioning member 182, the top surface of the extension post can abut against the front housing rear wall 18, and the locking column can penetrate the positioning hole such that the first circuit board 432 can be installed on the front housing rear wall 18.

In some embodiments, the shape of the extension post may be any of a cylinder, a triangular prism, a cube, a cuboid, and a polygonal prism, and the locking column may be any of a cylinder, a triangular prism, a cube, a cuboid, and a polygonal prism. The shape of the positioning hole may be any of a circle, a triangle, a square, a rectangle, and a polygon. For example, the shape of the extension post may be a cylinder, and the shape of the locking column may be a cylinder with a diameter that extends from the top surface of the extension post and is smaller than the diameter of the locking post. At this time, the shape of the positioning hole may be circular, such that the locking column can pass through the positioning hole. In another example, the shape of the extension post may be a cylinder, and the shape of the locking column may be a cuboid extending from the top surface of the extension post. At this time, the shape of the positioning hole may be rectangular, such that the locking column can pass through the positioning hole. In another example, the shape of the extension post may be a cuboid, and the shape of the locking column may be a triangular prism extending from the top surface of the extension post. At this time, the shape of the positioning hole may be a triangle, such that the locking column can pass through the positioning hole. The shape matching of the extension post and the positioning hole listed above is merely an example, and should not be understood as a limitation to the embodiments of the present disclosure.

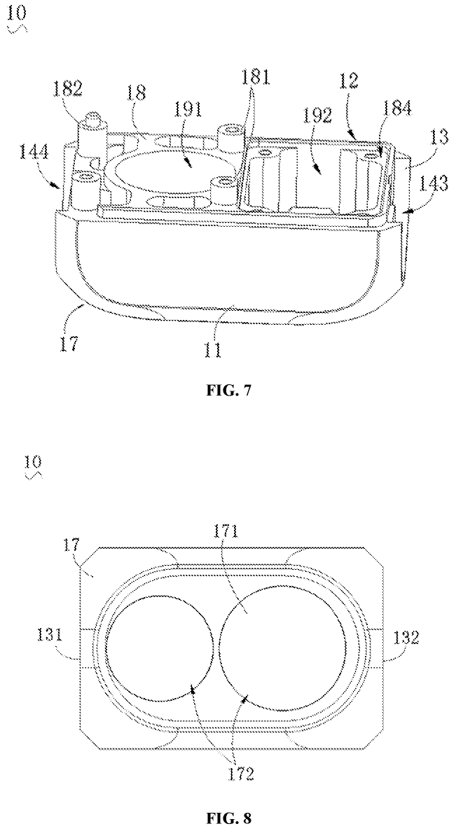

Referring to FIG. 8 and FIG. 12, in some embodiments, a sealing ring 45 can be used. A sleeve surface 4311 is formed on the first module body 431. When the first circuit board 432 is installed on the front housing rear wall 18, the sealing ring 45 can be sleeved on the first module body 431, and the sealing ring 45 can respectively abut against the sleeve surface 4311 and the top surface of the front housing rear wall 18. In this way, when the first module body 431 extends into the first storage space 191, the sealing ring 45 can seal the gap between the sleeve surface 4311 of the first module body 431 and the first storage space 191, and the sealing ring 45 and the transparent lens 70 or the light-transmitting area 171 can jointly seal the first storage space 191 to prevent moisture and dust from entering the first storage space 191. In this embodiment, the sleeve surface 4311 is a stepped surface. When the first module body 431 covered with the sealing ring 45 extends into the first storage space 191, the sealing ring 45 can seal the gap between the stepped surface of the first module body 431 and the first storage space 191. In other embodiments, the sleeve surface 4311 may also be a flat surface.

In some embodiments, a sealant can be used. When the first circuit board 432 is mounted on the front housing rear wall 18, the sealant can be disposed between a side surface 4321 of the first circuit board 432 and a side surface 1911 of the first storage space 191. In this way, the sealant and the transparent lens 70 or the light-transmitting area 171 can jointly seal the first storage space 191 to prevent the moisture, dust, etc., from entering the first storage space 191.

In this way, the first storage space 191 can be enclosed. In a highly humid environment, the lens of the first input and output module 43 will not affect the emission of the first light signal or the reception of the second light signal due to the appearance of moisture. In a dusty environment, the lens of the first input and output module 43 will not affect the emission of the first light signal or the reception of the second light signal due to dust.

Referring to FIG. 2, FIG. 6, and FIG. 12, the second input and output module 44 includes a second circuit board 442 and a second module body 441. The second circuit board 442 is mounted on the front housing rear wall 18 and/or the middle housing 20. The second module body 441 extends into the second storage space 192 and is aligned with the light-transmitting area 171, and the second circuit board 442 is received in the positioning groove 184. The contour of the positioning groove 184 may match the contour of the second circuit board 442. When the second circuit board 442 is received in the positioning groove 184, the positioning groove 184 can position the second circuit board 442 on the front housing rear wall 18.

A circuit board notch 4421 is disposed on the second circuit board 442. When the second circuit board 442 is mounted on the front housing rear wall 18, the circuit board notch 4421 may match with the protrusion 1842 on the bottom surface 1841 of the positioning groove 184. The protrusion 1842 and the circuit board notch 4421 can play a role of fool-proofing (that is, to prevent the second circuit board 442 from being reversed), and it is convenient to mount the second circuit board 442 on the front housing rear wall 18.

In some embodiments, a through hole 4422 is also formed on the second circuit board 442. When the second circuit board 442 is mounted on the front housing rear wall 18, the screw may pass through the through hole 4422 and screw into the screw hole 1843 opened in the positioning groove 184 to firmly connect the second circuit board 442 with the front housing rear wall 18.

In some embodiments, a second coupling member 4322 is also disposed on the second circuit board 442. The second coupling member 4322 can cooperate with the first coupling member 181 distributed around the second storage space 192 to mount the second circuit board 442 on the front housing rear wall 18. The first positioning member 182 may be an engaging hole opened on the second circuit board 442, or an engaging post extending from the second circuit board 442, or a through hole opened on the second circuit board 442.

Referring to FIG. 8 and FIG. 12, in some embodiments, a sealing ring (not shown in the accompanying drawings) can be used, and a sleeve surface 4411 is formed on the second module body 441. When the second circuit board 442 is mounted on the front housing rear wall 18, the sealing ring can be sleeved on the second module body 441, and the sealing ring 45 can respectively abut against the sleeve surface 4411 and the inner surface of the second storage space 192. In this way, when the second module body 441 extends into the second storage space 192, the sealing ring can seal the gap between the sleeve surface 4411 of the second module body 441 and the second storage space 192, and the sealing ring and the transparent lens 70 or the light-transmitting area 171 can jointly seal the second storage space 192 to prevent moisture, dust, etc. from entering the second storage space 192.

Referring to FIG. 2, FIG. 5, and FIG. 12, in some embodiments, a sealant can be used. When the second circuit board 442 is mounted on the front housing rear wall 18, the sealant can be disposed between a side surface 4423 of the second circuit board 442 and a side surface 1921 of the second storage space 192. In this way, the sealant and the transparent lens 70 or the light-transmitting area 171 can jointly seal the second storage space 192 to prevent moisture, dust, etc. from entering the second storage space 192.

In this way, the second storage space 192 can be enclosed. In a highly humid environment, the lens of the second input and output module 44 will not affect the emission of the first light signal or the reception of the second light signal due to the appearance of moisture. In a dusty environment, the lens of the second input and output module 44 will not affect the emission of the first light signal or the reception of the second light signal due to dust.

In some embodiments, when the input and output component 100 includes a first input and output module 43 and a second input and output module 44, the first module body 431 is received in the first storage space 191, and the second module body 441 is received in the second storage space 192, the optical axis of the first input and output module 43 may be parallel to the optical axis of the second input and output module 44, thereby ensuring that eh first input and output module 43 and the second input and output module 44 are arranged in parallel.

In some embodiments, the plane on which the optical axis of the first input and output module 43 and the optical axis of the second input and output module 44 are positioned may be parallel to a top surface 112 of the front housing top wall 11.

In some embodiments, an end of the first module body 431 extending into the first storage space 191 and an end of the first circuit board 432 extending into the second storage space 192 may be in the same plane. In this way, when the two input and output modules 40 are both imaging modules, the fields of view of the two imaging modules can overlap as much as possible, which is beneficial to the combination between the two images captured by the two imaging modules.

Take the first input and output module 43 as a visible light camera module, and the second input and output module 44 as a thermal imaging camera module as an example, in the process of a car chase at night, since the brightness of the environment at night is too dark, in order to identify the license plate number of the vehicle in front, it is needed to take a thermal imaging image by using a thermal imaging camera module, and a visible light image with a visible light camera module. Subsequently, the outline of the numbers or letters in the license plate can be recognized based on the visible light image, and the color of the numbers of letters in the license plate can be filled in based on the thermal imaging image, thereby identifying the license plate number. In some embodiments, the field of view between the thermal imaging camera module and the visible light camera module may need to overlap as much as possible, otherwise, the visible light camera module may capture the complete license plate, but thermal imaging camera module may only capture part of the license plate or may not capture the license plate. As a result, feature matching cannot be performed between the visible light image and the thermal imaging image, and the license plate number cannot be recognized.

Referring to FIG. 2 to FIG. 4, FIG. 12, and FIG. 14, the input and output component 100 further includes a heat sink 50. The heat sink 50 is received in the middle housing 20 and is in contact with the circuit board 42 and the middle housing 20 respectively. In some embodiments, when there is one heat sink 50, the heat sink 50 may be installed on the side close to the middle housing 20 on the first circuit board 432 or on the side close to the middle housing 20 on the second circuit board 442. When there are a plurality of heat sinks 50, the number of the heat sinks 50 may correspond to the number of circuit boards 42 in a one-to-one correspondence, and each heat sink 50 may be mounted on the corresponding circuit board 42 on the side close to the middle housing 20.

The heat sink 50 includes a heat dissipation body 51 and a heat dissipation protrusion 52 extending from the heat dissipation body 51. When the heat sink 50 is mounted on the circuit board 42, the heat dissipation body 51 may be spaced from the substrate 421 to form a gap, and the electronic components 422 can be positioned in the gap. A thermally conductive material, such as thermally conductive silicone grease, may be disposed between the heat dissipation protrusion 52 and the substrate 421, and the heat of the substrate 421 may be transferred to the heat dissipation body 51 through the heat dissipation protrusion 52 to realize the heat dissipation of the substrate 421. The heat dissipation body 51 may be in contact with the middle housing 20, the heat dissipation body 51 may transfer the heat transferred from the heat dissipation protrusion 52 to the middle housing 20, and the middle housing 20 may radiate the heat into the space. The material of the heat sink 50 and the middle housing 20 can be aluminum alloy. Aluminum alloy has the advantages of light weight, good thermal conductivity, high hardness, and low price, which can meet the heat dissipation requirement, and reduce the weight of the input and output component 100 and the manufacturing cost of the input and output component 100.

In some embodiments, the heat sink 50 may be mounted on the side of the first circuit board 432 that is close to the middle housing 20. The heat sink 50 may be received in the middle housing 20 and may be in contact with the first circuit board 432 and the middle housing 20 respectively. A third coupling member 53 is disposed on the heat sink 50. When the heat sink 50 is mounted on the first circuit board 432, the first coupling member 181, the second coupling member 4322, and the third coupling member 53 may cooperate. In some embodiments, the number of the first coupling member 181, the second coupling member 4322, and the third coupling member 53 may be the same.

In some embodiments, the first coupling member 181 may be an engaging post extending from the rear wall of the front housing 10, the second coupling member 4322 may be a circuit board engaging hole opened on the first circuit board 432, and the third coupling member 53 may be a heat sink engaging hole opened on the heat sink. When the first coupling member 181, the second coupling member 4322, and the third coupling member 53 are matched, the engaging post may sequentially pass through the circuit board engaging hole and the heat sink engaging hole to be engaged with the circuit board engaging hole and the heat sink engaging hole, such that the front housing rear wall 18, the first circuit board 432, and the heat sink 50 can be firmly connected in sequence.

In some embodiments, the first coupling member 181 may be a front housing engaging hole opened on the front housing rear wall 18, the second coupling member 4322 may be a circuit board engaging hole opened on the first circuit board 432, and the third coupling member 53 may be an engaging post extending from the heat sink 50. When the first coupling member 181, the second coupling member 4322, and the third coupling member 53 are matched, the engaging post may sequentially pass through the circuit board engaging post and the front housing engaging post to be engaged with the circuit board engaging post and the front housing engaging post, such that the heat sink 50, the first circuit board 432, and the front housing rear wall 18 can be firmly connected in sequence.

In some embodiments, the first coupling member 181 may include a cylinder with a threaded hole and a screw extending from the front housing rear wall 18, the second coupling member 4322 may be a circuit board through hole opened on the first circuit board 432, and the third coupling member 53 may be a heat sink through hole opened on the heat sink. When the first coupling member 181, the second coupling member 4322, and the third coupling member 53 are matched, the screw may pass through the through hole of the heat sink and the through hole of the circuit board in sequence to be screwed with the threaded hole to cause the heat sink 50, the first circuit board 432, and the front housing rear wall 18 to be firmly connected in sequence.

In some embodiments, the heat sink 50 may be mounted on the side close to the middle housing 20 on the second circuit board 442, and the heat sink 50 may be received in the middle housing 20 and may be in contact with the second circuit board 442 and the middle housing 20 respectively. A through hole may be opened on the heat sink 50. When the heat sink 50 is mounted on the second circuit board 442, the screw may pass through the through hole of the heat sink 50 and the through hole 4422 of the second circuit board 442 in sequence, and may be screwed with the screw hole 1843 opened on the positioning groove 184 to cause the heat sink 50, the second circuit board 442, and the front housing rear wall 18 to be firmly connected in sequence. In some embodiments, the number of the through holes of the heat sink 50 may be the same as the number of through holes 4422 of the second circuit board 442 and the number of the screw holes 1843 of the positioning groove 184.

In some embodiments, for the plurality of input and output modules 40, the heat sink 50 may only be installed on the circuit board 42 of the input and output module 40 that generates more heat, on the side close to the middle housing 20. Take the first input and output module 43 as a visible light camera module and the second input and output module 44 as a thermal imaging camera module as an example, the visible light camera module may generate more heat when working, and the thermal imaging camera module may generate less heat when working. At this time, the heat sink 50 may only be installed on the side of the circuit board 42 of the visible light camera module close to the middle housing 20 to dissipate heat from the circuit board 42 of the visible light camera module.

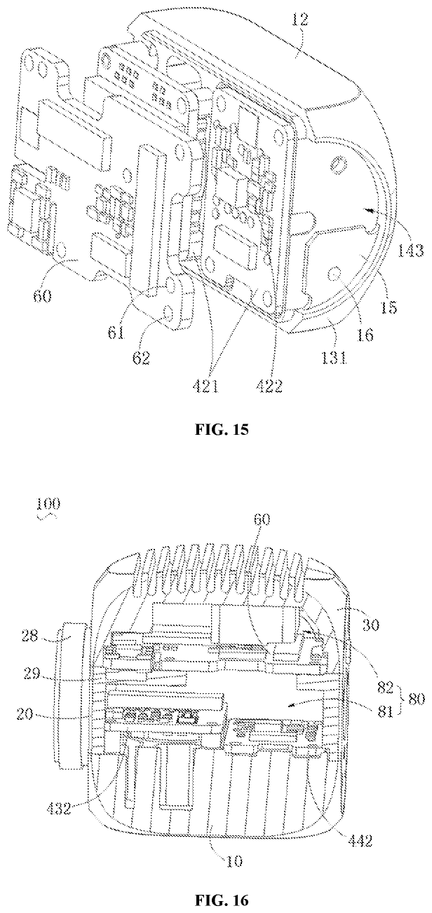

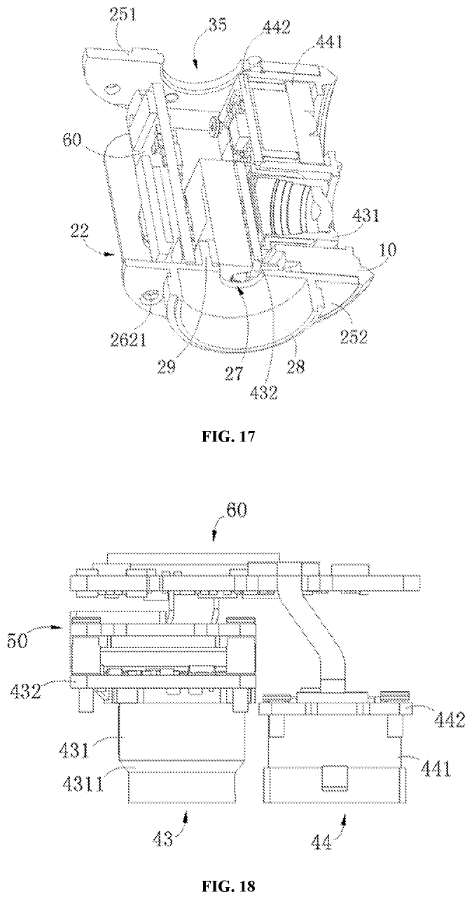

Referring to FIG. 2 to FIG. 4, and FIG. 15 to FIG. 18, the input and output component 100 further includes a main board 60, and the main board 60 can be used to provide power for the plurality of input and output modules 40. More specifically, the working voltages of the plurality of input and output modules 40 may be different, and the main board 60 can be used to adjust the voltage such that the voltage can meet the requirements of the respective input and output module 40. The main board 60 may be disposed between the middle housing 20 and the rear housing 30, and installed on the middle housing 20 and/or the rear housing 30. The main board 60 may be received in the second sub-receiving cavity 82, and the wiring of the main board 60 may pass through the wiring hole 35 of the middle housing side wall 25.

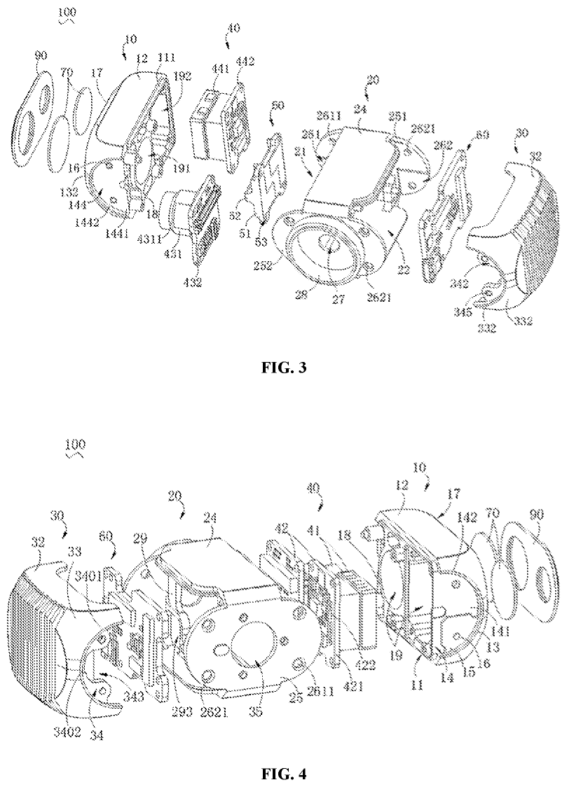

Referring to FIG. 3, FIG. 9, and FIG. 15, a second positioning mechanism 61 is disposed on the main board 60. When the main board 60 is installed on the middle housing 20, the second positioning mechanism 61 may cooperate with the first positioning mechanism 291 on the partition wall 29 to position the main board 60 and the partition wall 29. In some embodiments, the second positioning mechanism 61 may include a positioning hole opened on the main board 60. Correspondingly, the first positioning mechanism 291 may include an extension post extending form the partition wall 29 and a locking column extending from the top surface of the extension post. When the first positioning mechanism 291 cooperates with the second positioning mechanism 61, the main board 60 may be carried on the top surface of the extension post, and the locking column may pass through the positioning hole such that the main board 60 can be installed on the partition wall 29. In another embodiment, the second positioning mechanism 61 may include an extension post extending from the main board 60 and a locking column extending from the top surface of the extension post. Correspondingly, the first positioning mechanism 291 may include a positioning hole opened on the partition wall 29. When the first positioning mechanism 291 cooperate with the second positioning mechanism 61, the top surface of the extension post may be in contact with the partition wall 29, and the locking column may pass through the positioning hole such that the main board 60 can be installed on the partition wall 29. In another embodiment, the second positioning mechanism 61 may include an engaging post extending from the main board 60. Correspondingly, the first positioning mechanism 291 may include an engaging hole opened on the partition wall 29. When the first positioning mechanism 291 cooperates with the second positioning mechanism 61, the engaging post may be matched with the engaging hole. In another embodiment, the second positioning mechanism 61 may include an engaging hole opened on the main board 60. Correspondingly, the first positioning mechanism 291 may include an engaging post extending from the partition wall 29. When the first positioning mechanism 291 cooperates with the second positioning mechanism 61, the engaging post may be matched with the engaging hole.

The second connecting mechanism 62 may include an engaging hole opened on the main board 60. Correspondingly, the first connection mechanism 292 may include an engaging post extending from the partition wall 29. When the first connection mechanism 292 cooperates with the second connecting mechanism 62, the engaging post may be matched with the engaging hole such that the main board 60 and the partition wall 29 can be fixedly connected. In one embodiment, the second connecting mechanism 62 may be an engaging hole opened on the main board 60. Correspondingly, the first connection mechanism 292 may be an engaging post extending from the partition wall 29. When the first connection mechanism 292 cooperates with the second connecting mechanism 62, the engaging hole may be engaged with the engaging post. In another embodiment, the second connecting mechanism 62 may be an engaging post extending from the main board 60. Correspondingly, the first connection mechanism 292 may be an engaging hole opened on the partition wall 29. When the first connection mechanism 292 cooperates with the second connecting mechanism 62, the engaging hole may be engaged with the engaging post. The second connecting mechanism 62 may also be a through hole opened on the main board 60. Correspondingly, the first connection mechanism 292 may include a cylinder with a threaded hole and a screw extending from the partition wall 29. When the first positioning mechanism 291 and the second connecting mechanism 62 cooperate, the screw may pass through the through hole and screwed with the threaded hole.

The main board 60 also includes electronic components. In one embodiment, part of the electronic components on the main board 60 may be received in a receiving groove 293 of the partition wall 29. In this way, the gap between the main board 60 and the partition wall 29 can be reduced, and the size of the input and output component 100 can be further reduced. In another embodiment, the receiving groove 293 may be filled with damping material, which can reduce the influence of jitter on the electronic components on the main board 60. When the input and output component 100 shakes, the electronic components on the main board 60 will not be damaged due to collision.

In the input and output component 100 provided in the embodiments of the present disclosure, the input and output component 100 includes a three-stage design, such that once the input and output component 100 is damaged, there is no need to replace it as a whole, and only one of the three-stage structure needs to be replaced. When the input and output module 40 installed in the receiving cavity 80 is damaged, only the input and output module 40 may be replaced, and the input and output component 100 does not need to be replaced as a whole. In addition, when the circuit board 42 of the input and output module 40 is connected to the main board 60, the three-stage design can reduce the length of the wire between the circuit board 42 of the input and output module 40 and the main board 60, which can further reduce the space occupied by the circuit board 42 and the main board 60, and can reduce the interference of wires on the electronic components on the main board 60 or the electronic components 422 on the circuit board 42. Further, the input and output module 40 can be installed on the front housing 10 and/or the middle housing 20, which can reduce the accumulation of the assembly size chain, reduce the accumulation of the dimensional tolerances, and further reduce the size of the input and output component 100, which is beneficial to the integration of the input and output component 100 on the small gimbal 200.

In addition, a plurality of input and output modules 40 can be installed on the same front housing rear wall 18 with positioning and connection functions. The user does not need to adjust the optical axes of the plurality of input and output modules 40 for the optical axes of the input and output modules 40 to be parallel to each other, which facilitates the calibration and installation of the input and output modules 40.

Further, the input and output component 100 can be equipped with a plurality of input and output modules 40 at the same time, and the plurality of input and output modules 40 can be used together to make the input and output component 100 suitable for a variety of application scenarios to meet the needs of the users.

Furthermore, the input and output module 40 may be a modular design, and users can replace the input and output module 40 in the input and output component 100 based on needs, thereby further improving the universality of the input and output component 100 and meet the users' needs.

In addition, the input and output module 40 can include a sealing structure such as a sealing ring 45, a sealant, a transparent lens 70, etc., which can seal the first storage space 191 and the second storage space 192. In highly humid or dusty environment, the input and output module 40 will not be affected by moisture or dust on the lens.

Referring to FIG. 19, an embodiment of the present disclosure further provides a gimbal system 1000. The gimbal system 1000 includes a gimbal 200 and the input and output component 100 described in any one of the above embodiments. The input and output component 100 is installed on the gimbal 200. In this embodiment, the input and output component 100 is a dual-vision camera.

In some embodiments, when the input and output component 100 is installed on the gimbal 200, the connection between the input and output component 100 and the gimbal 200 may be a direct connection between the front housing 10 of the input and output component 100 and the gimbal 200; or, it may be a direction connection between the middle housing 20 of the input and output component 100 and the gimbal 200; or, it may be a direct connection between the rear housing 30 of the input and output component 100 and the gimbal 200; or, the front housing 10 and the middle housing 20 may be both connected to the gimbal 200 at the same time; or, the front housing 10 and the rear housing 30 may be both connected to the gimbal 200 at the same time; or, the middle housing 20 and the rear housing 30 may be both connected to the gimbal 200 at the same time; or, the front housing 10, the middle housing 20, and the rear housing 30 may all be connected to the gimbal 200 at the same time; or, the input and output component 100 may be directly connected to the gimbal 200 through at least one of the front housing 10, the middle housing 20, and the rear housing 30, and may also be directly connected to the gimbal 200 through other components other than the front housing 10, the middle housing 20, and the rear housing 30 at the same time, where the other components may be the components in the input and output component 100; or, the input and output component 100 may be directly connected to the gimbal 200 through at least one of the front housing 10, the middle housing 20, and the rear housing 30, and may also be directly connected to the gimbal 200 through other components other than the front housing 10, the middle housing 20, and the rear housing 30 at the same time, where the other components may not be the components in the input and output component 100; or, the input and output component 100 may only be directly connected to the gimbal 200 through other components other than the front housing 10, the middle housing 20, and the rear housing 30, where the other components may be the components of the input and output component 100; or, the input and output component 100 may only be indirectly connected to the gimbal 200 through the other components other than the front housing 10, the middle housing 20, and the rear housing 30, where the other components may not be the components of the input and output component 100.

An embodiment of the present disclosure further provides a movable platform. The movable platform may include a movable platform body and the gimbal system 1000 described above. The gimbal system 1000 can be installed on the movable platform body. In some embodiments, the movable platform may be a UAV, a vehicle, a ship, a movable robot, etc., which is not limited in the embodiments of the present disclosure.

Referring to FIG. 20, the movable platform is a UAV 3000, and the gimbal 1000 is disposed on a UAV body 2000 of the UAV 3000. By combining the UAV 3000 with the input and output component 100, it can be applied to scenes that require multi-light combination, such as forest fire prevention and car chasing at night.

In the present description, descriptions of reference terms such as “an embodiment,” “some embodiments,” “illustrative embodiment,” “example,” “specific example,” or “some examples,” mean that characteristics, structures, materials, or features described in relation to the embodiment or example are included in at least one embodiment or example of the present disclosure. In the present description, illustrative expression of the above terms does not necessarily mean the same embodiment or example. Further, specific characteristics, structures, materials, or features may be combined in one or multiple embodiments or examples in a suitable manner.

Moreover, terms of “first” and “second” are only used for description and cannot be seen as indicating or implying relative importance or indicating or implying the number of the indicated technical features. Thus, the features defined with “first” and “second” may comprise or imply at least one of these features. In the description of the present disclosure, “a plurality of” means two or more than two, unless specified otherwise.

The above descriptions of various embodiments of the present disclosure are illustrative, and do not limit the scope of the present disclosure. A person having ordinary skills in the art can make changes, modifications, substitutions, and variations based on the present disclosure. The scope of the present disclosure is defined by the following claims and the equivalents.

What is claimed is:

1. A dual-vision camera, comprising:
a front housing;
a middle housing;
a rear housing;
a first camera module; and
a second camera module, wherein
the front housing, the middle housing, and the rear housing are connected in sequence to form a receiving cavity, the front housing including a front housing front wall and a front housing rear wall disposed opposite the front housing front wall, the front housing rear wall being disposed in the receiving cavity, and the front housing rear wall being recessed toward the front housing front wall forming a first storage space and a second storage space;
the first camera module includes a first circuit board and a first module body, the first circuit board being mounted on at least one of the front housing rear wall or the middle housing, and the first module body extending into the first storage space;
the second camera module includes a second circuit board and a second module body, the second circuit board being mounted on at least one of the front housing rear wall or the middle housing, and the second module body extending into the second storage space; and
a connecting part is disposed on the middle housing to connect the dual-vision camera and a gimbal.

2. The dual-vision camera of claim 1, wherein:
the first storage space and the second storage space are spaced apart; and
when the first module body is received in the first storage space and the second module body is received in the second storage space, an optical axis of the first camera module is parallel to an optical axis of the second camera module.

3. The dual-vision camera of claim 2, wherein;
the front housing further includes a front housing top wall connected with the front housing front wall and the front housing rear wall, a plane of the optical axis of the first camera module and the optical axis of the second camera module being parallel to a top surface of the front housing top wall; and
one end of the first module body extending into the first storage space and one end of the second module body extending into the second storage space are in a same plane.

4. The dual-vision camera of claim 1, wherein:
the front housing further includes a first positioning member disposed on the front housing rear wall, a second positioning member disposed on the first circuit board, the first positioning member cooperating with the second positioning member to position the first circuit board on the front housing rear wall; and
the front housing rear wall is recessed toward the front housing front wall to form a positioning groove, the positioning groove including the second storage space, and the when the second circuit board is disposed on at least one of the front housing rear wall or the middle housing, the second circuit board is received in the positioning groove.

5. The dual-vision camera of claim 4, wherein:
the first positioning member includes an extension post extending from the front housing rear wall and a locking column extending from a top surface of the extension post, the second positioning member is a positioning hole disposed on the first circuit board, the first circuit board being carried on the top surface of the extension post and the locking column passing through the positioning hole when the second positioning member cooperates with the first positioning member; or
the first positioning member is a positioning hole disposed on the front housing rear wall, the second positioning member includes an extension post extending from the first circuit board and a locking column extending from the top surface of the extension post, the top surface of the extension post abutting against the front housing rear wall and the locking column passing through the positioning hole when the second positioning member cooperates with the first positioning member.

6. The dual-vision camera of claim 4, wherein:
the front housing further includes a first coupling member disposed on the front housing rear wall, and a second coupling member disposed on the first circuit board and the second circuit board, the first coupling member and the second coupling member being matched and locked to fix the first circuit board and the second circuit board on the front housing; and
the first positioning member and two of more of the first coupling members are evenly distributed on the front housing rear wall around the first storage space, the two of more of the first coupling members being disposed in the positioning groove.

7. The dual-vision camera of claim 4, wherein:
a protrusion is disposed on a bottom surface of the positioning groove, and a circuit board notch is disposed on the second circuit board, the protrusion cooperating with the circuit board notch when the second circuit board is mounted on at least one of the front housing rear wall or the middle housing.

8. The dual-vision camera of claim 1, further comprising:
a main board disposed between the middle housing and the rear housing and installed on the middle housing or the rear housing to provide power to the first camera module and the second camera module.

9. The dual-vision camera of claim 1, wherein:
a sealing ring is sleeved on the first module body when the first circuit board is mounted on at least one of the front housing rear wall or the middle housing, the sealing ring respectively abutting against a sleeve surface of the first module body and the top surface of the front housing rear wall, and the sealing ring being disposed between a side surface of the second circuit board and a side surface of the positioning groove when the second circuit board is mounted on at least one of the front housing rear wall or the middle housing.

10. The dual-vision camera of claim 1, wherein:
the front housing rear wall further includes a plurality of weight reduction grooves, the plurality of weight reduction grooves being spaced apart from the first storage space and evenly distributed on the front housing rear wall.

11. The dual-vision camera of claim 1, further comprising:
a heat sink, the heat sink being mounted on a side of the first circuit board close to the middle housing, and the heat sink being received in the middle housing and respectively in contact with the first circuit board and the middle housing; and
a circuit board including a substrate and a plurality of electronic components disposed on the substrate, wherein
the heat sink includes a heat dissipation body and a heat dissipation protrusion extending from the heat dissipation body, the heat dissipation body being spaced from the substrate to form a gap, the plurality of electronic components being positioned in the gap, and a thermally conductive material being disposed between the heat dissipation protrusion and the substrate.

12. The dual-vision camera of claim 1, wherein:
the first camera module includes a visible light camera module, and the second camera module includes a thermal imaging camera module.

13. A gimbal system comprising:
a gimbal; and
a dual-vision camera being carried by the gimbal, the dual-vision camera including
a front housing;
a middle housing;
a rear housing;
a first camera module; and
a second camera module, wherein
the front housing, the middle housing, and the rear housing are connected in sequence to form a receiving cavity, the front housing including a front housing front wall and a front housing rear wall disposed opposite to the front housing front wall, the front housing rear wall being disposed in the receiving cavity, and the front housing rear wall being recessed toward the front housing front wall a first storage space and a second storage space;
the first camera module includes a first circuit board and a first module body, the first circuit board being mounted on at least one of the front housing rear wall or the middle housing, and the first module body extending into the first storage space;
the second camera module includes a second circuit board and a second module body, the second circuit board being mounted on at least one of the front housing rear wall or the middle housing, and the second module body extending into the second storage space; and
a connecting part is disposed on the middle housing to connect the dual-vision camera and the gimbal.

14. The gimbal system of claim 13, wherein:
the first storage space and the second storage space are spaced apart; and
when the first module body is received in the first storage space and the second module body is received in the second storage space, an optical axis of the first camera module is parallel to an optical axis of the second camera module.

15. The gimbal system of claim 14, wherein;
the front housing further includes a front housing top wall connected with the front housing front wall and the front housing rear wall, a plane of the optical axis of the first camera module and the optical axis of the second camera module being parallel to a top surface of the front housing top wall; and
one end of the first module body extending into the first storage space and one end of the second module body extending into the second storage space are in a same plane.

16. The gimbal system of claim 13, wherein:
the front housing further includes a first positioning member disposed on the front housing rear wall, a second positioning member disposed on the first circuit board, the first positioning member cooperating with the second positioning member to position the first circuit board on the front housing rear wall; and
the front housing rear wall is recessed toward the front housing front wall to form a positioning groove, the positioning groove including the second storage space, and the when the second circuit board is mounted on at least one of the front housing rear wall or on the middle housing, the second circuit board is received in the positioning groove.

17. The gimbal system of claim 13, further comprising:
a main board disposed between the middle housing and the rear housing and installed on the middle housing or the rear housing to provide power to the first camera module and the second camera module.

18. The gimbal system of claim 13, further comprising:
a heat sink, the heat sink being mounted on a side of the first circuit board close to the middle housing, and the heat sink being received in the middle housing and respectively in contact with the first circuit board and the middle housing; and
a circuit board including a substrate and a plurality of electronic components disposed on the substrate, wherein
the heat sink includes a heat dissipation body and a heat dissipation protrusion extending from the heat dissipation body, the heat dissipation body being spaced from the substrate to form a gap, the plurality of electronic components being positioned in the gap, and a thermally conductive material being disposed between the heat dissipation protrusion and the substrate.

19. The gimbal system of claim 13, wherein:
the first camera module includes a visible light camera module, and the second camera module includes a thermal imaging camera module.

20. A movable platform comprising:
a movable platform body; and
a gimbal system being installed on the movable platform body, the gimbal system including
a gimbal; and
a dual-vision camera being carried by the gimbal, the dual-vision camera including
a front housing;
a middle housing;
a rear housing;
a first camera module; and
a second camera module, wherein
the front housing, the middle housing, and the rear housing are connected in sequence to form a receiving cavity, the front housing including a front housing front wall and a front housing rear wall disposed opposite the front housing front wall, the front housing rear wall being disposed in the receiving cavity, and the front housing rear wall being recessed toward the front housing front wall, forming a first storage space and a second storage space;
the first camera module includes a first circuit board and a first module body, the first circuit board being mounted on at least one of the front housing rear wall or the middle housing, and the first module body extending into the first storage space;
the second camera module includes a second circuit board and a second module body, the second circuit board being mounted on at least one of the front housing rear wall or the middle housing, and the second module body extending into the second storage space; and
a connecting part is disposed on the middle housing to connect the dual-vision camera and the gimbal.
